(19) United States
(12) Patent Application Publication
(10) Pub. No.: US 2016/0182249 A1
(43) Pub. Date: Jun. 23, 2016

(54) EVENT-BASED AUDIO/VIDEO FEED SELECTION

(71) Applicant: EchoStar Technologies, L.L.C., Englewood, CO (US)

(72) Inventor: Mark Wayne Lea, Kennesaw, GA (US)

(21) Appl. No.: 14/577,717

(22) Filed: Dec. 19, 2014

(51) Int. Cl. H04L 12/28; H04N 21/436

(52) U.S. Cl. CPC H04L 12/2827; H04N 21/43615

(57) ABSTRACT

Commanding a presentation device, such as a television for example, to switch between audio/visual inputs or channels when it is determined that first audio/visual signals are to be supplied to the presentation device for output thereby, in place of second and different audio/visual signals currently or instantly output thereby.

### BACKGROUND

Home automation systems are becoming increasingly prevalent, the same of which may incorporate multiple smart devices that allow end-users to control and/or view status information for those devices. Systems and methods are contemplated herein to provide such users flexibility and convenience with respect to controlling and/or viewing status information for those and other devices incorporated into their home automation system.

### SUMMARY

In an aspect, a method may include or comprise: detecting, by a home automation system, a first command to establish a communication link between the home automation system and a particular presentation device; generating, by the home automation system in response to detecting the first command, a second command to enforce the particular presentation device to exhibit a particular output display mode or status; and transmitting, by the home automation system via the communication link, the second command to enforce the particular presentation device to exhibit the particular output display mode or status.

In an aspect, a home automation system may include or comprise: at least one processor; and at least one memory element communicatively coupled with and readable by at least one processor and having stored therein processor-readable instructions that, when executed by the at least one processor, cause the at least one processor to: detect a first command to establish a communication link between the home automation system and a particular presentation device; generate a second command to enforce the particular presentation device to exhibit a particular output display mode or status; and transmit via the communication link the second command to enforce the particular presentation device to exhibit the particular output display mode or status.

In an aspect, a computer-implemented method may include or comprise: detecting, by a television receiver, a first command to establish a communication link between the television receiver and a particular presentation device; generating, by the television receiver in response to detecting the first command, a second command to enforce the particular presentation device to exhibit a particular output display mode or status; and transmitting, by the television receiver via the communication link, the second command to enforce the particular presentation device to exhibit the particular output display mode or status.

Other aspects are possible.

### BRIEF DESCRIPTION OF THE DRAWINGS

FIG. 1 shows an example satellite system in accordance with the disclosure.

FIG. 2 shows an example block diagram of a television receiver.

FIG. 3 shows an example home automation system in accordance with the disclosure.

FIG. 4 shows first aspects of the example system of FIG. 4 in detail.

FIG. 5 shows an example method in accordance with the disclosure.

FIG. 6 shows second aspects of the example system of FIG. 4 in detail

FIG. 7 shows an example computing system or device.

### DETAILED DESCRIPTION

The present disclosure is directed to or towards systems and methods for commanding a presentation device, such as a television for example, to switch between A/V (Audio/Visual) inputs when it is determined that “higher” priority A/V signals are to be supplied to the presentation device for output thereby, in place of “lower” priority A/V signals currently or instantly output thereby. Such an implementation may be analogous to forcibly switching between A/V inputs so that preferred or priority content may be output for display by the presentation device, and the same may be beneficial and/or advantageous in many different scenarios.

For example, a hybrid satellite television/home automation system is contemplated whereby a stand-alone home automation gateway device may be inserted in series between a television receiver and a television. The home automation gateway device in general may be configured and/or arranged to receive data or signals, either directly or indirectly, from various home automation-related devices or components each positioned at a particular location within a residence, and may further be programmed to output for display by the television certain home automation-related content when applicable or as desired. As an example, the home automation gateway device may be programmed such that upon detection of an individual approaching a front door of the residence, a security camera may be automatically activated and the security camera feed may be supplied to the television for display thereby. In this manner, someone watching television at the time the individual approaches the front door may optionally view the security camera feed in order to come to quick understanding of who the individual is and take measures accordingly.

In this scenario, the television may not necessarily be set to an A/V input that would allow for the someone watching television at the time the individual approaches the front door to actually view the security camera feed. For instance, a third party device, such as a Roku® device for example, may be connected to the television that which is switched to a particular A/V input that would allow for the person to watch content supplied by the third party device to the television, but is different than an A/V input that would allow for the person to watch or otherwise access the security camera feed as supplied by the home automation gateway device. Here, because the A/V input is set to enable viewing of content supplied the third party device, and not set to enable viewing of content supplied by the home automation gateway device, the video feed will not necessarily be output by the television. Accordingly, the someone watching television at the time the individual approaches the front door will be unable to come to quick understanding of who the individual approaching the door is and take measures accordingly.

As discussed in detail below, the features or aspects of the present disclosure address this and other issues by enabling the home automation gateway device to detect when such a conflict(s) exists, and then command the presentation device, without additional user-input, to switch to a particular A/V input so that certain home automation-related information may be presented in accordance with an intended use of the home automation gateway device. Advantageously, such an implementation may serve to entice new customers to subscribe to home automation services as offered by a particular satellite television provider, together or in tandem with typical satellite television programming related services, as well as provide an incentive for existing customers to maintain their loyalty and/or relationship with the satellite television provider. Although not so limited, an appreciation of the various aspects of the present disclosure may be gained from the following discussion in connection with the drawings.

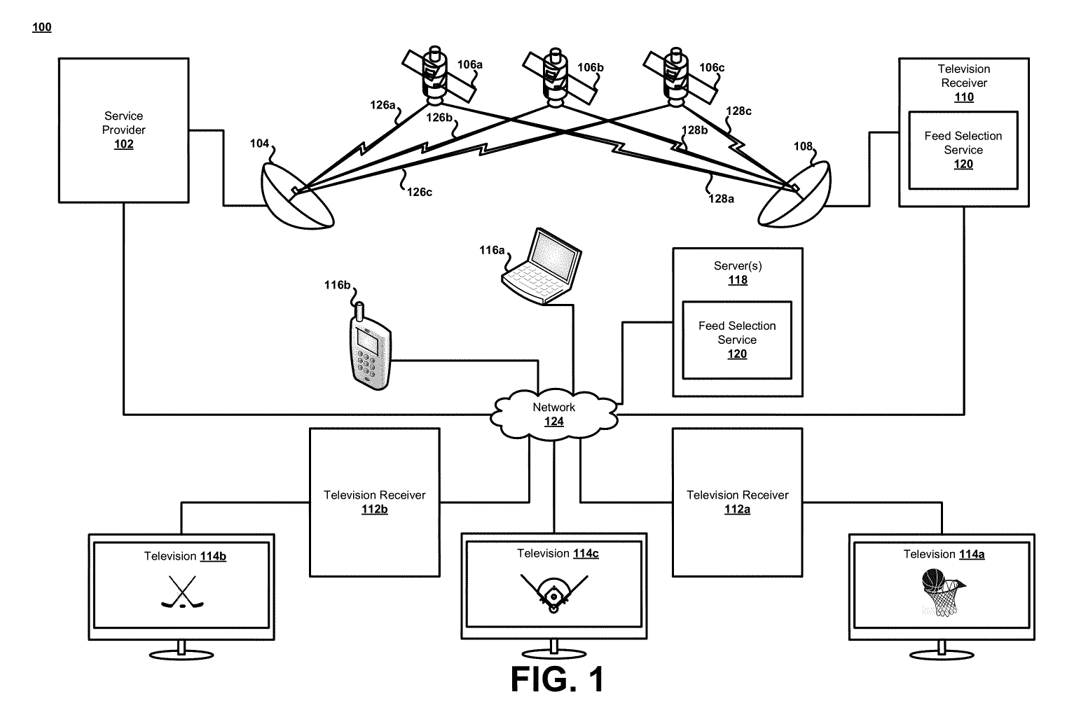

For instance, referring now to FIG. 1, an example satellite television distribution system 100 is shown in accordance with the present disclosure. For brevity, the system 100 is depicted in a simplified form, and may include more or fewer systems, devices, networks, and/or other components as desired. Further, number and type of features or elements incorporated within the system 100 may or may not be implementation-specific, and at least some of the aspects of the system 100 may be similar to a cable television distribution system, an IPTV (Internet Protocol Television) content distribution system, and/or any other type of content distribution system.

The example system 100 may include a service provider 102, a satellite uplink 104, a plurality of satellites 106a-c, a satellite dish 108, a PTR (Primary Television Receiver) 110, a plurality of STRs (Secondary Television Receivers) 112a-b, a plurality of televisions 114a-c, a plurality of computing devices 116a-b, and at least one server 118 that may in general be associated with or operated or implemented by the service provider 102. Additionally, the PTR 110 and the server 118 may include or otherwise exhibit a FSS (Feed Selection Service) module 120. In general, the FSS module 120 may be configured and/or arranged for commanding a presentation device, such as the television 114c for example, to switch between A/V (Audio/Visual) inputs when it is determined that “higher” priority A/V signals are to be supplied to the television 114c for output thereby, in place of “lower” priority A/V signals currently or instantly output thereby, in accordance with the principles of the present disclosure. The present disclosure though is not so limited, as may be understood from the following discussion in connection with the drawings.

The system 100 may further include at least one network 124 that establishes a bidirectional communication path for data transfer between and among each respective element of the system 100, outside or separate from the unidirectional satellite signaling path. The network 124 is intended to represent any number of terrestrial and/or non-terrestrial network features or elements. For example, the network 124 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular communications network, or any other type of communication network configured such that data may be transferred between and among elements of the system 100.

The PTR 110, and the STRs 112a-b, as described throughout may generally be any type of television receiver, television converter, etc., such as a STB for example. In another example, the PTR 110, and the STRs 112a-b, may exhibit functionality integrated as part of or into a television, a DVR (Digital Video Recorder), a computer such as a tablet computing device, or any other computing system or device, as well as variations thereof. Further, the PTR 110 and the network 124, together with the STRs 112a-b and televisions 114a-c, and possibly the computing devices 116a-b, may each be incorporated within or form at least a portion of a particular home computing network.

Further, the PTR 110 may be configured so as to enable communications in accordance with any particular communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/CEC (High-Definition Multimedia Interface/High-bandwidth Digital Content Protection), etc. Other examples are possible. For example, one or more of the various elements or components of the example system 100 may be configured to communicate in accordance with the MoCA® (Multimedia over Coax Alliance) home entertainment networking standard. Still other examples are possible.

In practice, the satellites 106a-c may each be configured to receive uplink signals 126a-c from the satellite uplink 104. In this example, each the uplink signals 126a-c may contain one or more transponder streams of particular data or content, such as one or more particular television channels, as supplied by the service provider 102. For example, each of the respective uplink signals 126a-c may contain various media or media content such as encoded HD (High Definition) television channels, SD (Standard Definition) television channels, on-demand programming, programming information, and/or any other content in the form of at least one transponder stream, and in accordance with an allotted carrier frequency and bandwidth. In this example, different media content may be carried using different ones of the satellites 106a-c.

Further, different media content may be carried using different transponders of a particular satellite (e.g., satellite 106a); thus, such media content may be transmitted at different frequencies and/or different frequency ranges. For example, a first and second television channel may be carried on a first carrier frequency over a first transponder of satellite 106a, and a third, fourth, and fifth television channel may be carried on second carrier frequency over a first transponder of satellite 106b, or, the third, fourth, and fifth television channel may be carried on a second carrier frequency over a second transponder of satellite 106a, and etc. Each of these television channels may be scrambled such that unauthorized persons are prevented from accessing the television channels.

The satellites 106a-c may further be configured to relay the uplink signals 126a-c to the satellite dish 108 as downlink signals 128a-c. Similar to the uplink signals 126a-c, each of the downlink signals 128a-c may contain one or more transponder streams of particular data or content, such as various encoded and/or at least partially electronically scrambled television channels, on-demand programming, etc., in accordance with an allotted carrier frequency and bandwidth. The downlink signals 128a-c, however, may not necessarily contain the same or similar content as a corresponding one of the uplink signals 126a-c. For example, the uplink signal 126a may include a first transponder stream containing at least a first group or grouping of television channels, and the downlink signal 128a may include a second transponder stream containing at least a second, different group or grouping of television channels. In other examples, the first and second group of television channels may have one or more television channels in common. In sum, there may be varying degrees of correlation between the uplink signals 126a-c and the downlink signals 128a-c, both in terms of content and underlying characteristics.

Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, ESPN®, and etc. Further, the term “channel,” may in some contexts carry a different meaning from or than its normal, plain language meaning. For example, the term “channel” may denote a particular carrier frequency or sub-band which can be tuned to by a particular tuner of a television receiver. In other contexts though, the term “channel” may refer to a single program/content service such as HBO®.

Additionally, a single satellite may typically have multiple transponders (e.g., 32 transponders) each one broadcasting a channel or frequency band of about 24-27 MHz in a broader frequency or polarity band of about 500 MHz. Thus, a frequency band of about 500 MHz may contain numerous sub-bands or channels of about 24-27 MHz, and each channel in turn may carry a combined stream of digital data comprising a number of content services. For example, a particular hypothetical transponder may carry HBO®, CBS®, ESPN®, plus several other channels, while another particular hypothetical transponder may itself carry 3, 4, 5, 6, etc., different channels depending on the bandwidth of the particular transponder and the amount of that bandwidth occupied by any particular channel or service on that transponder stream. Further, in many instances a single satellite may broadcast two orthogonal polarity bands of about 500 MHz. For example, a first polarity band of about 500 MHz broadcast by a particular satellite may be left-hand circular polarized, and a second polarity band of about 500 MHz may be right-hand circular polarized. Other examples are possible.

Continuing with the example scenario, the satellite dish 108 may be provided for use to receive television channels (e.g., on a subscription basis) provided by the service provider 102, satellite uplink 104, and/or satellites 106a-c. For example, the satellite dish 108 may be configured to receive particular transponder streams, or downlink signals 128a-c, from one or more of the satellites 106a-c. Based on the characteristics of the PTR 110 and/or satellite dish 108, however, it may only be possible to capture transponder streams from a limited number of transponders concurrently. For example, a particular tuner of the PTR 110 may be configured to tune to a single transponder stream from a transponder of a single satellite at a time.

Additionally, the PTR 110, which is communicatively coupled to the satellite dish 108, may subsequently select via tuner, decode, and relay particular transponder streams to the television 114c for display thereon. For example, the satellite dish 108 and the PTR 110 may, respectively, be configured to receive, decode, and relay at least one premium HD-formatted television channel to the television 114c. Programming or content associated with the HD channel may generally be presented live, or from a recording as previously stored on, by, or at the PTR 110. Here, the HD channel may be output to the television 114c in accordance with the HDMI/HDCP content protection technologies. Other examples are however possible.

Further, the PTR 110 may select via tuner, decode, and relay particular transponder streams to one or both of the STRs 112a-b, which may in turn relay particular transponder streams to a corresponding one of the televisions 114a-b for display thereon. For example, the satellite dish 108 and the PTR 110 may, respectively, be configured to receive, decode, and relay at least one television channel to the television 114a by way of the STR 112a. Similar to the above-example, the television channel may generally be presented live, or from a recording as previously stored on the PTR 110, and may be output to the television 114a by way of the STR 112a in accordance with a particular content protection technology and/or networking standard. Still further, the satellite dish 108 and the PTR 110 may, respectively, be configured to receive, decode, and relay at least one premium television channel to one or each of the computing devices 116a-c. Similar to the above-examples, the television channel may generally be presented live, or from a recording as previously stored on the PTR 110, and may be output to one or both of the computing devices 116a-c in accordance with a particular content protection technology and/or networking standard.

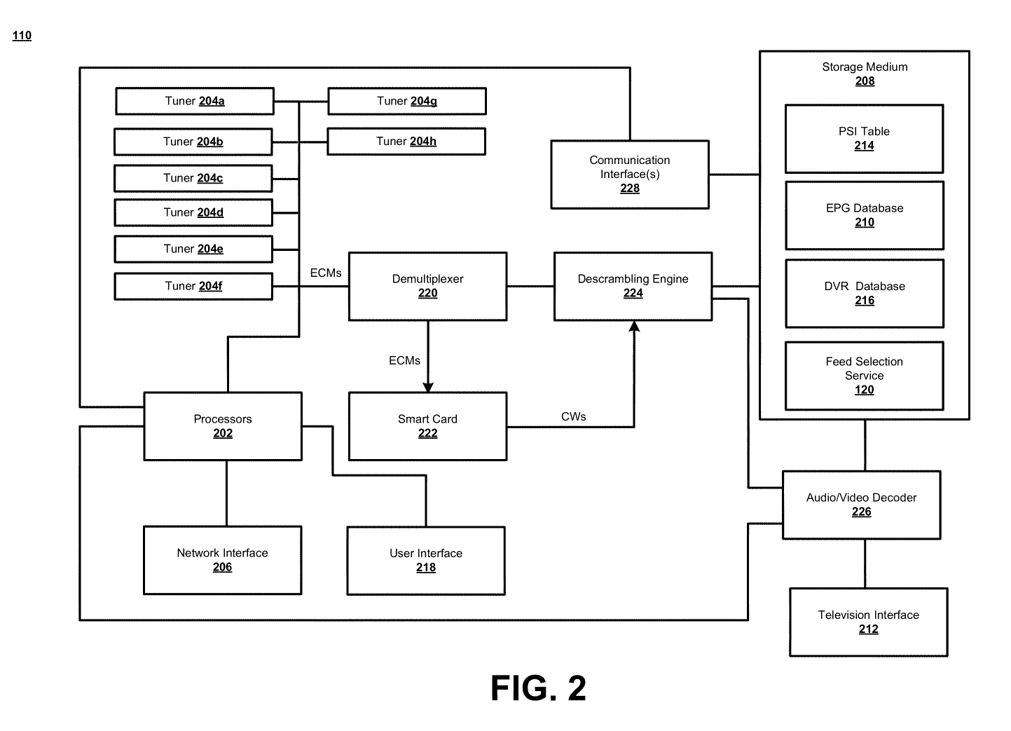

Referring now to FIG. 2, an example block diagram of the PTR 110 of FIG. 1 is shown in accordance with the disclosure. In some examples, the STRs 212a-b may be configured in a manner similar to that of the PTR 110. In some examples, the STRs 212a-b may be configured and arranged to exhibit a reduced functionality as compared to the PTR 110, and may depend at least to a certain degree on the PTR 110 to implement certain features or functionality. The STRs 212a-b in this example may be each referred to as a “thin client.”

The PTR 110 may include one or more processors 202, a plurality of tuners 204a-h, at least one network interface 206, at least one non-transitory computer-readable storage medium 208, at least one EPG database 210, at least one television interface 212, at least one PSI (Program Specific Information) table 214, at least one DVR database 216, at least one user interface 218, at least one demultiplexer 220, at least one smart card 222, at least one descrambling engine 224, at least one decoder 226, and at least one communication interface 228. In other examples, fewer or greater numbers of components may be present. Further, functionality of one or more components may be combined; for example, functions of the descrambling engine 224 may be performed by the processors 202. Still further, functionality of components may be distributed among additional components, and possibly additional systems such as, for example, in a cloud-computing implementation.

The processors 202 may include one or more specialized and/or general-purpose processors configured to perform processes such as tuning to a particular channel, accessing and displaying EPG information, and/or receiving and processing input from a user. For example, the processors 202 may include one or more processors dedicated to decoding video signals from a particular format, such as according to a particular MPEG (Motion Picture Experts Group) standard, for output and display on a television, and for performing or at least facilitating decryption or descrambling.

The tuners 204a-h may be used to tune to television channels, such as television channels transmitted via satellites 106a-c. Each one of the tuners 204a-h may be capable of receiving and processing a single stream of data from a satellite transponder, or a cable RF channel, at a given time. As such, a single tuner may tune to a single transponder or, for a cable network, a single cable channel. Additionally, one tuner (e.g., tuner 204a) may be used to tune to a television channel on a first transponder stream for display using a television, while another tuner (e.g., tuner 204b) may be used to tune to a television channel on a second transponder for recording and viewing at some other time. If multiple television channels transmitted on the same transponder stream are desired, a particular tuner (e.g., tuner 204c) may be used to receive the signal containing the multiple television channels for presentation and/or recording of each of the respective multiple television channels, such as in a PTAT (Primetime Anytime) implementation for example. Although eight tuners are shown, the PTR 110 may include more or fewer tuners (e.g., three tuners, sixteen tuners, etc.), and the features or aspects of the present disclosure may be implemented similarly and scale according to the number of tuners of the PTR 110.

The network interface 206 may be used to communicate via alternate communication channel(s) with a service provider. For example, the primary communication channel between the service provider 102 of FIG. 2 and the PTR 110 may be via satellites 106a-c, which may be unidirectional to the PTR 110, and another communication channel between the service provider 102 and the PTR 110, which may be bidirectional, may be via the network 124. In general, various types of information may be transmitted and/or received via the network interface 206.

The storage medium 208 may represent a non-transitory computer-readable storage medium. The storage medium 208 may include memory and/or a hard drive. The storage medium 208 may be used to store information received from one or more satellites and/or information received via the network interface 206. For example, the storage medium 208 may store information related to the EPG database 210, the PSI table 214, and/or the DVR database 216, among other elements or features, such as the FSS module 120 mentioned above. Recorded television programs may be stored using the storage medium 208 and ultimately accessed therefrom.

The EPG database 210 may store information related to television channels and the timing of programs appearing on such television channels. Information from the EPG database 210 may be used to inform users of what television channels or programs are available, popular and/or provide recommendations. Information from the EPG database 210 may be used to generate a visual interface displayed by a television that allows a user to browse and select television channels and/or television programs for viewing and/or recording. Information used to populate the EPG database 210 may be received via the network interface 206 and/or via satellites 106a-c of FIG. 2. For example, updates to the EPG database 210 may be received periodically or at least intermittently via satellite. The EPG database 210 may serve as an interface for a user to control DVR functions of the PTR 110, and/or to enable viewing and/or recording of multiple television channels simultaneously.

The decoder 226 may convert encoded video and audio into a format suitable for output to a display device. For instance, the decoder 226 may receive MPEG video and audio from the storage medium 208, or the descrambling engine 224, to be output to a television. MPEG video and audio from the storage medium 208 may have been recorded to the DVR database 216 as part of a previously-recorded television program. The decoder 226 may convert the MPEG video and audio into a format appropriate to be displayed by a television or other form of display device and audio into a format appropriate to be output from speakers, respectively. The decoder 226 may be a single hardware element capable of decoding a finite number of television channels at a given time, such as in a time-division arrangement. In the example embodiment, eight television channels may be decoded concurrently or simultaneously.

The television interface 212 output a signal to a television, or another form of display device, in a proper format for display of video and play back of audio. As such, the television interface 212 may output one or more television channels, stored television programming from the storage medium 208, such as television programs from the DVR database 216 and/or information from the EPG database 210 for example, to a television for presentation.

The PSI table 214 may store information used by the PTR 110 to access various television channels. Information used to populate the PSI table 214 may be received via satellite, or cable, through the tuners 204a-h and/or may be received via the network interface 206 over the network 124 from the service provider 102 shown in FIG. 1. Information present in the PSI table 214 may be periodically or at least intermittently updated. Information that may be present in the PSI table 214 may include: television channel numbers, satellite identifiers, frequency identifiers, transponder identifiers, ECM PIDs (Entitlement Control Message, Packet Identifier), one or more audio PIDs, and video PIDs. A second audio PID of a channel may correspond to a second audio program, such as in another language. In some examples, the PSI table 214 may be divided into a number of tables, such as a NIT (Network Information Table), a PAT (Program Association Table), and a PMT (Program Management Table).

Table 1 below provides a simplified example of the PSI table 214 for several television channels. It should be understood that in other examples, many more television channels may be represented in the PSI table 214. The PSI table 214 may be periodically or at least intermittently. As such, television channels may be reassigned to different satellites and/or transponders, and the PTR 110 may be able to handle this reassignment as long as the PSI table 214 is updated.

TABLE 1

| Channel | Satellite | Transponder | ECM PID | Audio PIDs | Video PID |
|---|---|---|---|---|---|
| 4 | 1 | 2 | 27 | 1001 | 1011 |
| 5 | 2 | 11 | 29 | 1002 | 1012 |
| 7 | 2 | 3 | 31 | 1003 | 1013 |
| 13 | 2 | 4 | 33 | 1003, 1004 | 1013 |

It should be understood that the values provided in Table 1 are for example purposes only. Actual values, including how satellites and transponders are identified, may vary. Additional information may also be stored in the PSI table 214. Video and/or audio for different television channels on different transponders may have the same PIDs. Such television channels may be differentiated based on which satellite and/or transponder to which a tuner is tuned.

DVR functionality of the PTR 110 may permit a television channel to be recorded for a period of time. The DVR database 216 may store timers that are used by the processors 202 to determine when a television channel should be tuned to and recorded to the DVR database 216 of storage medium 208. In some examples, a limited amount of space of the storage medium 208 may be devoted to the DVR database 216. Timers may be set by the service provider 102 and/or one or more users of the PTR 110. DVR functionality of the PTR 110 may be configured by a user to record particular television programs. The PSI table 214 may be used by the PTR 110 to determine the satellite, transponder, ECM PID, audio PID, and video PID.

The user interface 218 may include a remote control, physically separate from PTR 110, and/or one or more buttons on the PTR 110 that allows a user to interact with the PTR 110. The user interface 218 may be used to select a television channel for viewing, view information from the EPG database 210, and/or program a timer stored to the DVR database 216 wherein the timer may be used to control the DVR functionality of the PTR 110.

Referring back to the tuners 204a-h, television channels received via satellite may contain at least some encrypted or scrambled data. Packets of audio and video may be scrambled to prevent unauthorized users, such as nonsubscribers, from receiving television programming without paying the service provider 102. When one of the tuners 204a-h is receiving data from a particular transponder of a satellite, the transponder stream may be a series of data packets corresponding to multiple television channels. Each data packet may contain a PID, which in combination with the PSI table 214, can be determined to be associated with a particular television channel. Particular data packets, referred to as ECMs may be periodically transmitted. ECMs may be encrypted; the PTR 110 may use the smart card 222 to decrypt ECMs.

The smart card 222 may function as the CA (Controlled Access) which performs decryption of encryption data to obtain control words that are used to descramble video and/or audio of television channels. Decryption of an ECM may only be possible when the user (e.g., an individual who is associated with the PTR 110) has authorization to access the particular television channel associated with the ECM. When an ECM is received by the demultiplexer 220 and the ECM is determined to correspond to a television channel being stored and/or displayed, the ECM may be provided to the smart card 222 for decryption.

When the smart card 222 receives an encrypted ECM from the demultiplexer 220, the smart card 222 may decrypt the ECM to obtain some number of control words. In some examples, from each ECM received by the smart card 222, two control words are obtained. In some examples, when the smart card 222 receives an ECM, it compares the ECM to the previously received ECM. If the two ECMs match, the second ECM is not decrypted because the same control words would be obtained. In other examples, each ECM received by the smart card 222 is decrypted; however, if a second ECM matches a first ECM, the outputted control words will match; thus, effectively, the second ECM does not affect the control words output by the smart card 222. When an ECM is received by the smart card 222, it may take a period of time for the ECM to be decrypted to obtain the control words. As such, a period of time, such as about 0.2-0.5 seconds, may elapse before the control words indicated by the ECM can be obtained. The smart card 222 may be permanently part of the PTR 110 or may be configured to be inserted and removed from the PTR 110.

The demultiplexer 220 may be configured to filter data packets based on PIDs. For example, if a transponder data stream includes multiple television channels, data packets corresponding to a television channel that are not desired to be stored or displayed by the user may be ignored by the demultiplexer 220. As such, only data packets corresponding to the one or more television channels desired to be stored and/or displayed may be passed to either the descrambling engine 224 or the smart card 222; other data packets may be ignored. For each channel, a stream of video packets, a stream of audio packets and/or a stream of ECM packets may be present, each stream identified by a PID. In some examples, a common ECM stream may be used for multiple television channels. Additional data packets corresponding to other information, such as updates to the PSI table 214, may be appropriately routed by the demultiplexer 220.

The descrambling engine 224 may use the control words output by the smart card 222 in order to descramble video and/or audio corresponding to television channels for storage and/or presentation. Video and/or audio data contained in the transponder data stream received by the tuners 204a-h may be scrambled. The video and/or audio may be descrambled by the descrambling engine 224 using a particular control word. Which control word output by the smart card 222 to be used for successful descrambling may be indicated by a scramble control identifier present within the data packet containing the scrambled video or audio. Descrambled video and/or audio may be output by the descrambling engine 224 to the storage medium 208 for storage, such as part of the DVR database 216 for example, and/or to the decoder 226 for output to a television or other presentation equipment via the television interface 212.

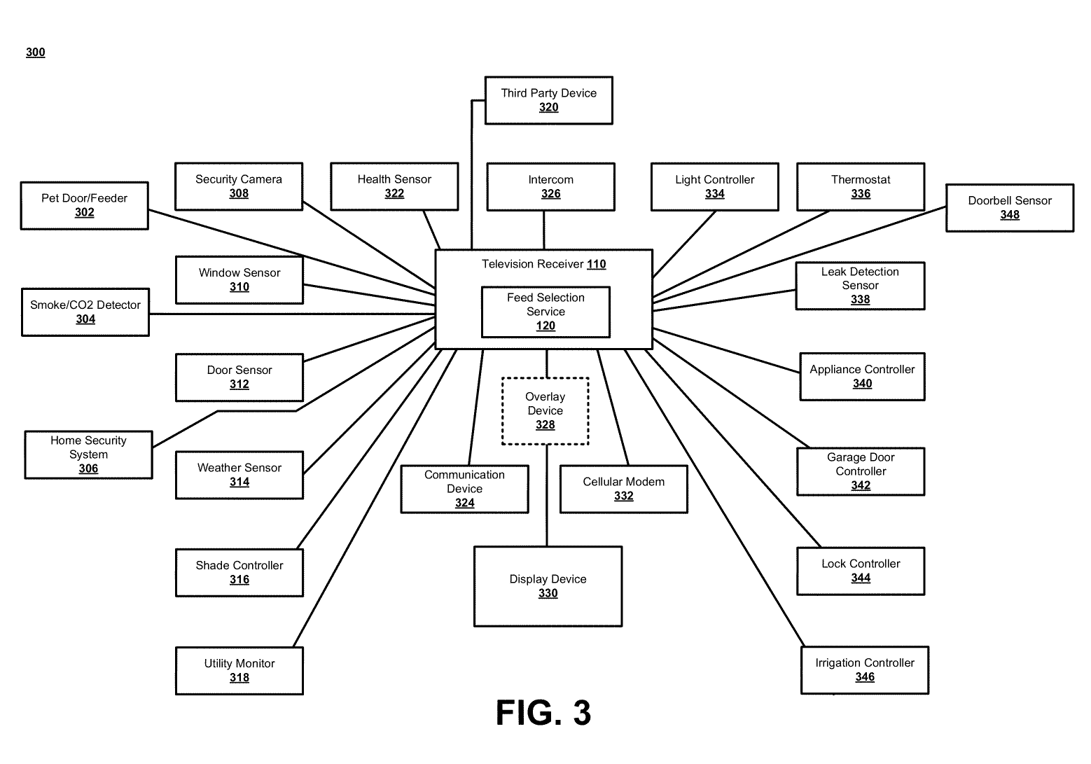

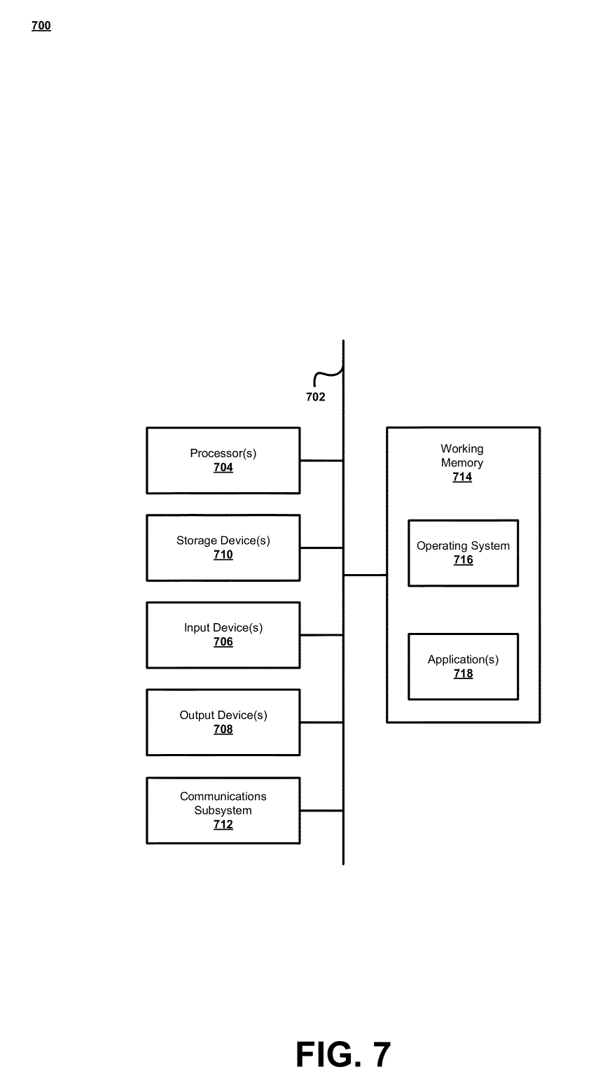

The communication interface 228 may be used by the PTR 110 to establish a communication link or connection between the PTR 110 and one or more of the computing systems and devices as shown in FIG. 1 and FIG. 3, discussed further below. It is contemplated that the communication interface 228 may take or exhibit any form as desired, and may be configured in a manner so as to be compatible with a like component or element incorporated within or to a particular one of the computing systems and devices as shown in FIG. 1 and FIG. 3, and further may be defined such that the communication link may be wired and/or or wireless. Example technologies consistent with the principles or aspects of the present disclosure may include, but are not limited to, Infrared, Bluetooth®, WiFi, NFC (Near Field Communication), HomePlug®, Zigbee®, Z-Wave®, etc., and/or any other communication device or subsystem similar to that discussed below in connection with FIG. 7.

For brevity, the PTR 110 is depicted in a simplified form, and may generally include more or fewer elements or components as desired, including those configured and/or arranged for implementing various features for enabling an end-user to access home automation features or functionality directly from or via one or more interfaces that might normally be used to access satellite television-related programming and services, in accordance with the principles of the present disclosure. For example, the PTR 110 is shown in FIG. 2 to include the FSS module 120 as mentioned above in connection with FIG. 1. While shown stored to the storage medium 208 as executable instructions, the FSS module 120 could, wholly or at least partially, be stored to the processor(s) 202 of the PTR 110. In this manner, various features or functionality of the FSS module 120 may be implemented by one or more physical or hardware components of the PTR 110, and similar comments may be made with respect to the server 118 of FIG. 1. Further, some routing between the various modules of PTR 110 is illustrated in FIG. 2. Such illustrations are for exemplary purposes only. The state of two modules not being directly or indirectly connected does not indicate the modules cannot communicate. Rather, connections between modules of the PTR 110 are intended only to indicate possible common data routing. It should be understood that the modules of the PTR 110 may be combined into a fewer number of modules or divided into a greater number of modules.

Additionally, although not explicitly shown in FIG. 2, the PTR 110 may include one or more logical modules configured to implement a television steaming media functionality that encodes video into a particular format for transmission over the Internet such as to allow users to remotely view and control a home cable, satellite, or personal video recorder system from an Internet-enabled computer with a broadband Internet connection. The Slingbox® by Sling Media, Inc. of Foster City, Calif., is one example of a product that implements such functionality. Further, the PTR 110 may be configured to include any number of other various components or logical modules that are implemented in hardware, software, firmware, or any combination thereof, and such components or logical modules may or may not be implementation-specific.

Referring now to FIG. 3, an example home automation system 300 is shown in accordance with the present disclosure. In an example, the home automation system 300 may be hosted by the PTR 110 of FIG. 1, and thus the PTR 110 may be considered a home automation gateway device or system. An overlay device 328 is also shown in FIG. 3. In another example, the home automation system 300 may be hosted by the overlay device 328 of FIG. 3, and thus the overlay device 328 may be considered a home automation gateway device or system. Still other examples are possible. For instance, in some example, features or functionality of the overlay device 328 may be wholly or at least partially incorporated into the PTR 110 (and vice versa), so that the home automation system 300 may be considered to be hosted or managed or controlled by both PTR 110 and the overlay device 328. In this manner, the PTR 110, the overlay device 328, or any combination of functionality thereof may be considered the “brain” or central feature or aspect of the example home automation system 300.

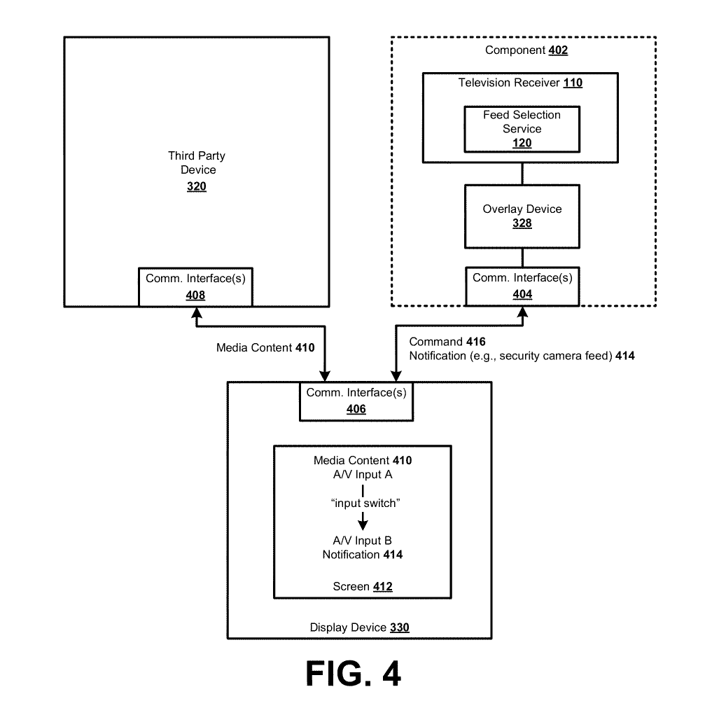

Accordingly, the PTR 110 and/or the overlay device 328 may be configured and/or arranged to communicate with multiple in-home or on-residence home automation-related systems and/or devices. Some examples of which include, but are not limited to: at least one pet door/feeder 302, at least one smoke/CO₂ detector 304, a home security system 306, at least one security camera 308, at least one window sensor 310, at least one door sensor 312, at least one weather sensor 314, at least one shade controller 316, at least one utility monitor 318, at least one third party device 320, at least one health sensor 322, at least one communication device 324, at least one intercom 326, at least one overlay device 328, at least one display device 330, at least one cellular modem 332, at least one light controller 334, at least one thermostat 336, at least one leak detection sensor 338, at least one appliance controller 340, at least one garage door controller 342, at least one lock controller 344, at least one irrigation controller 346, and at least one doorbell sensor 348. The home automation system 300 of FIG. 4 is just an example. Other examples are possible, as discussed further below.

It is contemplated that the each of the elements of FIG. 4, that which with the PTR 110 communicates, may use different communication standards. For example, one or more elements may use or otherwise leverage a ZigBee® communication protocol, while one or more other devices may communicate with the PTR 110 using a Z-Wave® communication protocol. As another example, one or more elements may use or otherwise leverage a WiFi communication protocol, while one or more other devices may communicate with the PTR 110 using a Bluetooth communication protocol. Any combination thereof is further contemplated, and other forms of wireless communication may be used by particular elements of FIG. 4 to enable communications to and from the PTR 110, such as any particular IEEE (Institute of Electrical and Electronics Engineers) standard or specification or protocol, such as the IEEE 702.11 technology for example.

In some examples, a separate device may be connected with the PTR 110 to enable communication with the smart home automation systems or devices of FIG. 4. For instance, the communication device 324 as shown coupled with the PTR 110 may take the form of a dongle. In some examples, the communication device 324 may be configured to allow for Zigbee®, Z-Wave®, and/or other forms of wireless communication. In some example, the communication device 324 may connect with the PTR 110 via a USB (Universal Serial Bus) port or via some other type of (e.g., wired) communication port. Accordingly, the communication device 324 may be powered by the PTR 110 or may be separately coupled with another different particular power source. In some examples, the PTR 110 may be enabled to communicate with a local wireless network and may use communication device in order to communicate with devices that use a ZigBee® communication protocol, Z-Wave® communication protocol, and/or some other wireless communication protocols.

In some examples, the communication device 324 may also serve to allow or enable additional components to be connected with the PTR 110. For instance, the communication device 324 may include additional audio/video inputs (e.g., HDMI), component, and/or composite inputs to allow for additional devices (e.g., Blu-Ray players) to be connected with the PTR 110. Such a connection may allow video comprising home automation information to be “overlaid” with television programming, both being output for display by a particular presentation device. Whether home automation information is overlaid onto video on display may be triggered based on a press of a remote control button by an end-user.

Regardless of whether the PTR 110 uses the communication device 242 to communicate with any particular home automation device shown in FIG. 4 or other particular home automation device not explicitly shown in FIG. 4, the PTR 110 may be configured to output home automation information for presentation via the display device 330. It is contemplated that the display device 330 could correspond to any particular one of the mobile devices 116a-b and televisions 114a-c as shown in FIG. 2. Still other examples are possible. Such information may be presented simultaneously, concurrently, in tandem, etc., with any particular television programming received by the PTR 110 via any particular communication channel as discussed above. It is further contemplated that the PTR 110 may also, at any particular instant or given time, output only television programming or only home automation information based on preferences or commands or selections of particular controls within an interface of or by any particular end-user. Furthermore, an end-user may be able to provide input to the PTR 110 to control the home automation system 300, in its entirety as hosted by the PTR 110 or by the overlay device 328, as discussed further below.

In some examples (indicated by intermittent line in FIG. 4), the overlay device 328 may be coupled with the PTR 110 to allow or enable home automation information to be presented via the display device 330. It is contemplated that the overlay device 328 may be configured and/or arranged to overlay information, such as home automation information, onto a signal that will ultimately enable the home automation information to be visually presented via the display device 330. In this example, the PTR 110 may receive, decode, descramble, decrypt, store, and/or output television programming. The PTR 110 may output a signal, such as in the form of an HDMI signal. Rather than being directly input to the display device 330, however, the output of the PTR 110 may be input to the overlay device 328. Here, the overlay device 328 may receive the video and/or audio output from the PTR 110.

The overlay device 328 may add additional information to the video and/or audio signal received from the PTR 110 so as to modify or augment or even “piggyback” on the same. That video and/or audio signal may then be output by the overlay device 328 to the display device 330 for presentation thereon. In some examples, the overlay device 328 may include or exhibit an HDMI input/output, with the HDMI output being connected to the display device 330. While FIG. 4 shows lines illustrating communication between the PTR 110 and other various devices, it will be appreciated that such communication may exist, in addition or in alternate via the communication device 324 and/or the overlay device 328. In other words, any particular input to the PTR 110 as shown in FIG. 4 may additionally, or alternatively, be supplied as input to one or both of the communication device 324 and the overlay device 328.

As alluded to above, the PTR 110 may be used to provide home automation functionality, but the overlay device 328 may be used to modify a particular signal so that particular home automation information may be presented via the display device 330. Further, the home automation functionality as detailed throughout in relation to the PTR 110 may alternatively be provided by or via the overlay device 328. Using the overlay device 328 to present automation information via the display device 330 may be beneficial and/or advantageous in many respects. For instance, it is contemplated that multiple devices may provide input video to the overlay device 328. For instance, the PTR 110 may provide television programming to the overlay device 328, a DVD/Blu-Ray player may provide video to the overlay device 328, and a separate IPTV device may stream other programming to the overlay device 328.

Regardless of the source of particular video/audio, the overlay device 328 may output video and/or audio that has been modified or augmented, etc., to include home automation information and then output to the display device 330. As such, regardless of the source of video/audio, the overlay device 328 may modify the audio/video to include home automation information and, possibly, solicit for user input. For instance, in some examples the overlay device 328 may have four video inputs (e.g., four HDMI inputs) and a single video output (e.g., an HDMI output). In other examples, the PTR 110 may exhibit such features or functionality. As such, a separate device, such as a Blu-ray player may be connected with a video input of the PTR 110, thus allowing the PTR 110 to overlay home automation information when content from the Blu-Ray player is being output to the display device 330.

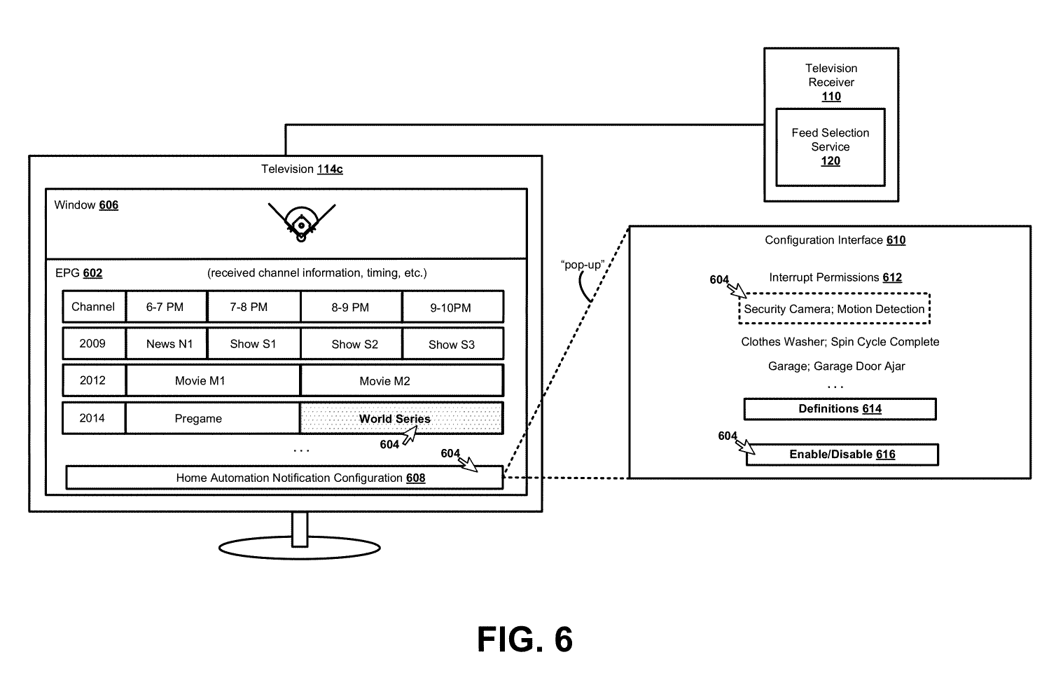

Regardless of whether the PTR 110 is itself configured to provide home automation functionality and output home automation input for display via the display device 330 or such home automation functionality is provided via the overlay device 328, home automation information may be presented by the display device 330 while television programming is also being presented by display device 330. For instance, home automation information may be overlaid or may replace a portion of television programming, such as broadcast content, stored content, on-demand content, etc., presented via the display device 330. As an example, FIG. 6 shows an example display by the television 114c of FIG. 1, the same of which is supplied to the television 114c by the PTR 110 which may be configured to host the home automation system 300 in accordance with the principles of the present disclosure. In FIG. 6, while television programming consisting of a baseball game is being presented, the display may be augmented with information related to home automation. In general, the television programming may represent broadcast programming, recorded content, on-demand content, or some other form of content.

An example of information related to home automation may include a security camera feed, as acquired by a camera at a front door of a residence. Such augmentation of the television programming may be performed directly by the PTR 110 (which may or may not be in communication with the communication device 242), the overlay device 328, or even a combination thereof. Such augmentation may result in solid or opaque or partially transparent graphics being overlaid onto television programming (or other forms of video) output by the PTR 110 and displayed by the television 114c. Furthermore, the overlay device 328 and/or the PTR 110 may add or modify sound to television programming also or alternatively. For instance, in response to a doorbell ring, a sound may be played through the television 114c (or connected audio system). In addition or in alternate, a graphic may be displayed. In other examples, other particular camera data (e.g., nanny camera data) and/or associated sound or motion sensors may be integrated in the system and overlaid or otherwise made available to a user. For example, detection of a crying baby from a nanny camera may trigger an on-screen alert to a user watching television.

Returning to FIG. 4 alone, the PTR 110 and/or the overlay device 328, depending on implementation-specific details, may communicate with one or more wireless devices, such as the third party device 320. The third party device 320 may represent a tablet computer, cellular phone, laptop computer, remote computer, or some other device through which a user may desire to control home automation settings and view home automation information in accordance with the principles of the present disclosure. Such a device also need not necessarily be wireless, such as in a desktop computer embodiment. It is contemplated that the PTR 110, communication device 324, and/or the overlay device 328 may communicate directly with the third party device 320, or may use a local wireless network, such as network 124 for instance. The third party device 320 may be remotely located and not connected with a same local wireless network as one or more of the other devices or elements of FIG. 4. Via the Internet, the PTR 110 and/or the overlay device 328 may transmit a notification to the third party device 320 regarding home automation information. For instance, a third-party notification server system, such as a notification server system operated by Apple Inc., of Cupertino, Calif. may be used to send such notifications to the third party device 320.

Various home automation devices may be in communication with the FSS module 120 of the PTR 110 (collectively, “PTR 110” throughout) and/or the overlay device 328, depending on implementation-specific details. Such home automation devices may use similar or disparate communication protocols. Such home automation devices may communicate with the PTR 110 directly or via the communication device 324. Such home automation devices may be controlled by a user and/or have a status viewed by a user via the display device 330 and/or third party device 320. Such home automation devices may include, but are not limited to:

One or more cameras, such as the security camera 308. It is contemplated that the security camera 308 may be installed indoors, outdoors, and may provide a video and/or an audio stream that may be presented via the third party device 320 and/or display device 330. Video and/or audio from the security camera 308 may be recorded by the overlay device 328 and/or the PTR 110 continuously, in a loop as per a predefined time period, upon an event occurring, such as motion being detected by the security camera 308, and etc. For example, video and/or audio from security camera 308 may be continuously recorded such as in the form of a rolling window, thus allowing a period of time of video/audio to be reviewed by a user from before a triggering event and after the triggering event. Video/audio may be recorded on a persistent storage device local to overlay device 328 and/or the PTR 110, and/or may be recorded and stored on an external storage devices, such as a network attached storage device or the server 118 of FIG. 2. In some examples, video may be transmitted across a local and/or wide area network to other one or more other storage devices upon occurrence of a trigger event, for later playback. For initial setup for example, a still may be captured by the security camera 308 and stored by the PTR 110 for subsequent presentation as part of a user interface via the display device 330. In this way, an end-user can determine which camera, if multiple cameras are present or enabled, is being set up and/or later accessed. For example, a user interface may display a still image from a front door camera (see e.g., FIG. 7), which may be easily recognized by the user because it shows a scene near or adjacent a front door of a residence, to allow a user to select the front door camera for viewing as desired.

Furthermore, video and, possibly, audio from the security camera 308 may be available live for viewing by a user via the overlay device 328 or the PTR 110. Such video may be presented simultaneously with television programming being presented. In some examples, video may only be presented if motion is detected by the security camera 308, otherwise video from the security camera 308 may not be presented by a particular display device presenting television programming. Also, such video (and, possibly, audio) from the security camera 308 may be recorded by the PTR 110 and/or the overlay device 328. As discussed in further detail below in connection with at least FIG. 8, such video may be recorded based upon a user-configurable timer. For instance, features or functionality associated with the security camera 308 may be incorporated into an EPG that is output by the PTR 110 for display by a presentation or display device.

For instance, data as captured by the security camera 308 may be presented or may otherwise be accessible as a “channel” as part of the EPG along with other typical or conventional television programming channels. Accordingly, a user may be permitted to select that channel associated with the security camera 308 to access data as captured by the security camera 308 for presentation via the display device 330 and/or the third party device 320, and etc. The user may also be permitted to set a timer to activate the security camera 308 to record video and/or audio for a user-defined period of time on a user-defined date. Such recording may not be constrained by the rolling window mentioned above associated with a triggering event being detected. Such an implementation may be beneficial, for example, if a babysitter is going to be watching a child and the parents want to later review the babysitter's behavior in their absence. In some examples, video and/audio acquired by the security camera 308 may be backed up to a remote storage device, such as cloud-based storage hosted by the server 118 of FIG. 1 for instance. Other data may also be cached to the cloud, such as configuration settings. Thus, if one or both of the PTR 110 and overlay device 328 malfunction, then a new device may be installed and the configuration data loaded onto the device from the cloud.

Further, one or more window sensors and door sensors, such as the window sensor 310 and the door sensor 312 may be integrated in to or as part of the home automation system 300, and each may transmit data to the PTR 110, possibly via the communication device 324, or the overlay device 328, that indicates the status of a window or door, respectively. Such status may indicate open window or door, an ajar window or door, a closed window or door, and etc. When a status change occurs, an end-user may be notified as such via the third party device 320 and/or the display device 330, within an EPG or like interface for example. Further, a user may be able to view a status screen within an EPG or other interface to view the status one or more window sensors and/or one or more door sensors throughout the location. In some examples, the window sensor 310 and/or the door sensor 312 may have integrated “break” sensors to enable a determination as to whether glass or a hinge, or other integral component, etc., has been broken or compromised. Here, as well as in all instances of home automation related data as acquired and served to the PTR 110 and/or overlay device 328 by particular elements of FIG. 3, it is contemplated that one or both of the window sensor 310 and the door sensor 312 may be controlled via interaction with particular controls as provided within or by an EPG or like interface, and information or data as acquired by one or both of the window sensor 310 and door sensor 312 may be manipulated, consolidated, etc., as desired, and also made accessible within or by an EPG or like interface, such as a pop-up window, banner, and/or any other “interface” or “display” or the like, in accordance with the principles of the present disclosure.

Further, one or more smoke and/or CO₂ detectors, such as detector 304, may be integrated in to or as part of the home automation system 300. As such, alerts as to whether a fire (e.g., heat, smoke), CO₂, radon, etc., has been detected can be sent to the PTR 110, third party device 320, etc., and/or one or more emergency first responders. Accordingly, when an alert occurs, a user may be notified as such the via third party device 320 or the display device 330, within an EPG or like interface for example. Further, it is contemplated that such an interface may be utilized to disable false alarms, and that one or more sensors dispersed throughout a residence and/or integrated within the home automation system 300 to detect gas leaks, radon, or various other dangerous situations. Here, as well as in all instances of home automation related data as acquired and served to the PTR 110 and/or overlay device 328 by particular elements of FIG. 4, the detector 304 may be controlled via interaction with particular controls as provided within or by an EPG or like interface, and information or data as acquired by the detector 304 may be manipulated, consolidated, etc., as desired, and also made accessible within or by an EPG or like interface in accordance with the principles of the present disclosure.

Further, a pet door and/or feeder, such as pet door and/or feeder 302 may be integrated in to or as part of the home automation system 300. For instance, a predefined amount of food may be dispensed at predefined times to a pet. A pet door may be locked and/or unlocked. The pet's weight or presence may trigger the locking or unlocking of the pet door. For instance, a camera located at the pet door may be used to perform image recognition of the pet or a weight sensor near the door may identify the presence of the pet and unlock the door. A user may also lock/unlock a pet door and/or dispense food for example from a “remote” location. Here, as well as in all instances of home automation related data as acquired and served to the PTR 110 and/or overlay device 328 by particular elements of FIG. 4, the pet door and/or feeder 302 may be controlled via interaction with particular controls as provided within or by an EPG or like interface, and information or data as acquired by the pet door and/or feeder 302 may be consolidated, summarized, etc., and made accessible within or by an EPG or like interface in accordance with the principles of the present disclosure.

Further, a weather sensor, such as the weather sensor 314 may be integrated in to or as part of the home automation system 300, and may allow or enable the PTR 110 and/or overlay device 328 to receive, identify, and/or output various forms of environmental data, including local or non-local ambient temperature, humidity, wind speed, barometric pressure, etc. Here, as well as in all instances of home automation related data as acquired and served to the PTR 110 and/or overlay device 328 by particular elements of FIG. 3, the weather sensor 314 may be controlled via interaction with particular controls as provided within or by an EPG or like interface, and information or data as acquired by the pet door and/or feeder 302 may be manipulated, consolidated, etc., as desired, and also made accessible within or by an EPG or like interface in accordance with the principles of the present disclosure.

Further, a shade controller, such as shade controller 316, may be integrated in to or as part of the home automation system 300, and may allow for control of one or more shades, such as window, door, and/or skylight shades, within a home or residence or any other location. The shade controller 316 may respond to commands received from the PTR 110 and/or overlay device 328 and may provide status updates, such as “shade up” or “shade 50% up” or “shade down” and etc. Here, as well as in all instances of home automation related data as acquired and served to the PTR 110 and/or overlay device 328 by particular elements of FIG. 4, the shade controller 316 may be controlled via interaction with particular controls as provided within or by an EPG or like interface, and information or data as acquired by the shade controller 316 may be manipulated, consolidated, etc., as desired, and also made accessible within or by an EPG or like interface in accordance with the principles of the present disclosure.

Further, a utility monitor, such as utility monitor 318, may be integrated in to or as part of the home automation system 300, and may serve to provide the PTR 110 and/or overlay device 328 with utility data or information, such as electricity usage, gas usage, water usage, wastewater usage, irrigation usage, etc. A user may via an EPG or like interface view a status page or may receive notifications upon predefined events occurring, such as electricity usage exceeding a defined threshold within a month, or current kilowatt usage exceeding a threshold. Here, as well as in all instances of home automation related data as acquired and served to the PTR 110 and/or overlay device 328 by particular elements of FIG. 3, the utility monitor 318 may be controlled via interaction with particular controls as provided within or by an EPG or like interface, and information or data as acquired by the utility monitor 318 may be manipulated, consolidated, etc., as desired, and also made accessible within or by an EPG or like interface in accordance with the principles of the present disclosure.

Further, a health sensor, such as health sensor 322, may be integrated in to or as part of the home automation system 300, and may permit one or more vital characteristics of a particular individual to be acquired and/or monitored, such as a heart rate for instance. In some examples, additionally or alternatively, the health sensor 322 may contain a button or other type of actuator that a user can press to request assistance. As such, the health sensor 322 may be mounted to a fixed location, such as bedside, or may be carried by a user, such as on a lanyard. Such a request may trigger a notification to be presented to other users via the display device 330 and/or the third party device 320. Additionally or if the notification is not cleared by another user within a predefined period of time, a notification may be transmitted to emergency first responders to request help. In some examples, a home automation service provider may first try contacting the user, such as via phone, to determine if an emergency is indeed occurring. Such a health sensor 322 may have additional purposes, such as for notification of another form of emergency, such as a break-in, fire, flood, theft, disaster, etc.

In some examples, the health sensor 322 may be used as a medical alert pendant that can be worn or otherwise carried by an individual. It may contain a microphone and/or speaker to allow communication with other users and/or emergency first responders. The PTR 110 and/or overlay device 328 may be preprogrammed to contact a particular phone number, such as an emergency service provider, relative, caregiver, etc., based on an actuator of the health sensor 322 being activated by a user. The user may be placed in contact with a person via the phone number and the microphone and/or speaker of the health sensor 322. Furthermore, camera data may be combined with such alerts in order to give a contacted relative more information regarding the medical situation. For example, the health sensor 322, when activated in the family room, may generate a command which is linked with security camera footage from the same room. Furthermore, in some examples, the health sensor 322 may be able to monitor vitals of a user, such as a blood pressure, temperature, heart rate, blood sugar, etc. In some examples, an event, such as a fall or exiting a structure can be detected.

Further, in response to an alert from the health sensor 322 or some other emergency or noteworthy event, parallel notifications may be sent to multiple users at approximately the same time. As such, multiple people can be made aware of the event at approximately the same time (as opposed to serial notification). Therefore, whoever the event is most pertinent to or notices the notification first can respond. Which users are notified for which type of event may be customized by a user of the PTR 110. In addition to such parallel notifications being based on data from the health sensor 322, data from other devices may trigger such parallel notifications. For instance, a mailbox open, a garage door open, an entry/exit door open during wrong time, an unauthorized control of specific lights during vacation period, a water sensor detecting a leak or flow, a temperature of room or equipment is outside of defined range, and/or motion detected at front door are examples of possible events which may trigger parallel notifications.

Additionally, a configuring user may be able to select from a list of users to notify and method of notification to enable such parallel notifications. The configuring user may prioritize which systems and people are notified, and specify that the notification may continue through the list unless acknowledged either electronically or by human interaction. For example, the user could specify that they want to be notified of any light switch operation in their home during their vacation. Notification priority could be: 1) SMS Message; 2) push notification; 3) electronic voice recorder places call to primary number; and 4) electronic voice recorder places call to spouse's number. Other examples are possible, however, it is contemplated that the second notification may never happen if the user replies to the SMS message with an acknowledgment. Or, the second notification would automatically happen if the SMS gateway cannot be contacted. Here, as well as in all instances of home automation related data as acquired and served to the PTR 110 and/or overlay device 328 by particular elements of FIG. 3, the health sensor 322 may be controlled via interaction with particular controls as provided within or by an EPG or like interface, and information or data as acquired by the health sensor 322 may be manipulated, consolidated, etc., as desired, and also made accessible within or by an EPG or like interface in accordance with the principles of the present disclosure.

Further, an intercom, such as the intercom 326, may be integrated in to or as part of the home automation system 300, and may permit a user in one location to communicate with a user in another location, who may be using the third party device 320, the display device 330, or some other device, such another television receiver within the structure. The intercom 326 may be integrated with the security camera 308 or may use a dedicated microphone/speaker, such as a Bluetooth® microphone. Microphones/speakers of the third party device 320, display device 330, communication device 242, overlay device 328, etc., may also or alternatively be used. A MOCA network or other appropriate type of network may be used to provide audio and/or video from the intercom 326 to the PTR 110 and/or to other television receivers and/or wireless devices in communication with the PTR 110. Here, as well as in all instances of home automation related data as acquired and served to the PTR 110 and/or overlay device 328 by particular elements of FIG. 3, the intercom 326 may be controlled via interaction with particular controls as provided within or by an EPG or like interface, and information or data as acquired by the intercom 326 may be manipulated, consolidated, etc., as desired, and also made accessible within or by an EPG or like interface in accordance with the principles of the present disclosure.

Further, a light controller, such as light controller 334, may be integrated in to or as part of the home automation system 300, and may permit a light to be turned on, off, and/or dimmed by the PTR 110 or the overlay device 328, such as based on a user command received from the third party device 320 or directly via PTR 110 or overlay device 328, etc. The light controller 334 may control a single light. As such, multiple different ones of the light controller 334 may be present within a house or residence. In some examples, a physical light switch, that opens and closes a circuit of the light, may be left in the “on” position such that light controller 334 can be used to control whether the light is on or off. The light controller 334 may be integrated into a light bulb or a circuit, such as between the light fixture and the power source, to control whether the light is on or off. An end-user, via the PTR 110 or overlay device 328, may be permitted to view a status of each instance of the light controller 334 within a location.

Since the PTR 110 or overlay device 328 may communicate using different home automation protocols, different instances of the light controller 334 within a location may use disparate or different communication protocols, but may all still be controlled by the PTR 110 or overlay device 328. In some examples, wireless light switches may be used that communicate with the PTR 110 or overlay device 328. Such switches may use a different communication protocol than any particular instance of the light controller 334. Such a difference may not affect functionality because the PTR 110 or overlay device 328 can serve as a hub for multiple disparate communication protocols and perform any necessary translation and/or bridging functions. For example, a tablet computer may transmit a command over a WiFi connection and the PTR 110 or overlay device 328 may translate the command into an appropriate Zigbee® or Zwave® command for a wireless light bulb. In some examples, the translation may occur for a group of disparate or different devices. For example, a user may decide to turn off all lights in a room and select a lighting command on a tablet computer, the overlay device 328 may then identify the lights in the room and output appropriate commands to all devices over different protocols, such as a Zigbee® wireless light bulb and a Zwave® table lamp.

Additionally, it is contemplated that the PTR 110 may permit timers and/or dimmer settings to be set for lights via the light controller 334. For instance, lights can be configured to turn on/off at various times during a day according to a schedule and/or events being detected by the home automation system 300, etc. Here, as well as in all instances of home automation related data as acquired and served to the PTR 110 and/or overlay device 328 by particular elements of FIG. 3, each particular instance of the light controller 334 may be controlled via interaction with particular controls as provided within or by an EPG or like interface, and information or data as acquired by each particular instance of the light controller 334 may be manipulated, consolidated, etc., as desired, and also made accessible within or by an EPG or like interface in accordance with the principles of the present disclosure.

Further, a thermostat, such as the thermostat 336, may be integrated in to or as part of the home automation system 300, and may provide heating/cooling updates to the PTR 110 and/or overlay device 328 for display via display device 330 and/or third party device 320. Further, control of thermostat 336 may be effectuated via the PTR 110 or overlay device 328, and zone control within a structure using multiple thermostats may also be possible. Here, as well as in all instances of home automation related data as acquired and served to the PTR 110 and/or overlay device 328 by particular elements of FIG. 3, the thermostat 336 may be controlled via interaction with particular controls as provided within or by an EPG or like interface, and information or data as acquired by the thermostat 336 may be manipulated, consolidated, etc., as desired, and also made accessible within or by an EPG or like interface in accordance with the principles of the present disclosure.

Further, a leak detection sensor, such as the leak detection sensor 338, may be integrated in to or as part of the home automation system 300, and may be used to determine when a water leak as occurred, such as in pipes supplying water-based fixtures with water. The leak detection sensor 338 may be configured to attach to the exterior of a pipe and listen for a sound of water moving within a pipe. In other examples, sonar, temperature sensors or ion infused water with appropriate sensors may be used to detect moving water. As such, cutting or otherwise modifying plumbing may not be necessary to use or leverage the leak detection sensor 338. If water movement is detected for greater than a threshold period of time, it may be determined a leak is occurring. The leak detection sensor 338 may have a component that couples over an existing valve such that the flow of water within one or more pipes can be stopped.

For instance, if the leak detection sensor 338 determines a leak may be occurring, a notification may be provided to a user via the third party device 320 and/or display device 330 by the PTR 110 and/or overlay device 328. If a user does not clear the notification, the flow of water may be shut off by the leak detection sensor 338 after a predefined period of time. A user may also be able to provide input to allow the flow of water to continue or to immediately interrupt the flow of water. Here, as well as in all instances of home automation related data as acquired and served to the PTR 110 and/or overlay device 328 by particular elements of FIG. 3, the leak detection sensor 338 may be controlled via interaction with particular controls as provided within or by an EPG or like interface, and information or data as acquired by the leak detection sensor 338 may be manipulated, consolidated, etc., as desired, and also made accessible within or by an EPG or like interface in accordance with the principles of the present disclosure.

Further, an applicant controller, such as the appliance controller 340, may be integrated in to or as part of the home automation system 300, and may permit a status of an appliance to be retrieved and commands to control operation to be sent to an appliance by the PTR 110 or overlay device 328. For instance, the appliance controller 340 may control a washing machine, a dryer, a dishwasher, an oven, a microwave, a refrigerator, a toaster, a coffee maker, a hot tub, or any other form of appliance. The appliance controller 340 may be connected with a particular appliance or may be integrated as part of the appliance. Additionally, or alternatively, the appliance controller 340 may enable for acquisition of data or information regarding electricity usage of one or more devices (e.g., other home automation devices or circuits within a home that are monitored) to be determined. Here, as well as in all instances of home automation related data as acquired and served to the PTR 110 and/or overlay device 328 by particular elements of FIG. 3, the appliance controller 340 may be controlled via interaction with particular controls as provided within or by an EPG or like interface, and information or data as acquired by the appliance controller 340 may be manipulated, consolidated, etc., as desired, and also made accessible within or by an EPG or like interface in accordance with the principles of the present disclosure.

Further, a garage door controller, such as the garage door controller 342, may be integrated in to or as part of the home automation system 300, and may permit a status of a garage door to be checked and the door to be opened or closed by a user via the PTR 110 or overlay device 328. In some examples, based on a physical location of the third party device 320, the garage door may be controlled. For instance, if the third party device 320 is a cellular phone and it is detected to have moved a threshold distance away from a house having the garage door controller 342 installed, a notification may be sent to the third party device 320. If no response is received within a threshold period of time, the garage may be automatically shut. If the third party device 320 moves within a threshold distance of the garage door controller 342, the garage may be opened. Here, as well as in all instances of home automation related data as acquired and served to the PTR 110 and/or overlay device 328 by particular elements of FIG. 3, the garage door controller 342 may be controlled via interaction with particular controls as provided within or by an EPG or like interface, and information or data as acquired by the garage door controller 342 may be manipulated, consolidated, etc., as desired, and also made accessible within or by an EPG or like interface in accordance with the principles of the present disclosure.

Further, a lock controller, such as the lock controller 344, may be integrated in to or as part of the home automation system 300, and may permit a door to be locked and unlocked and/or monitored by a user via the PTR 110 or overlay device 328. In some examples, the lock controller 344 may have an integrated door sensor 312 to determine if the door is open, shut, or partially ajar. Being able to only determine if a door is locked or unlocked may not be overly useful—for instance, a lock may be in a locked position, but if the door is ajar, the lock may not prevent access to the house. Therefore, for security, a user may benefit from knowing both that a door is closed (or open) and locked (or unlocked). To accomplish such notification and control, the lock controller 344 may have an integrated door sensor 312 that allows for the lock controller 344 to lock/unlock a door and provide a status as to whether the door is open or shut. Therefore, a single device may control a lock and determine whether the associated door is shut or open. No mechanical or electrical component may need to be integrated separately into a door or doorframe to provide such functionality. Such a single device may have a single power source that allows for sensing of the lock position, sensing of the door position, and for engagement/disengagement of the lock.

For example, the lock controller 344 may have an integrated door sensor that includes a reed switch or proximity sensor that detects when the door is in a closed position, with a plate of the lock in proximity to a plate on the door frame of the door. For instance, a plate of the lock may have an integrated magnet or magnetized doorframe plate. When in proximity to the magnet, a reed switch located in the lock controller 344 may be used to determine that the door is closed; when not in proximity to the magnet, the reed switch located in the lock controller 344 may be used to determine that the door is at least partially ajar. Rather than using a reed switch, other forms of sensing may also be used, such as a proximity sensor to detect a doorframe. In some examples, the sensor to determine the door is shut may be integrated directly into the deadbolt or other latching mechanism of the lock controller 344. When the deadbolt is extended, a sensor may be able to determine if the distal end of the deadbolt is properly latched within a door frame based on a proximity sensor or other sensing means. Here, as well as in all instances of home automation related data as acquired and served to the PTR 110 and/or overlay device 328 by particular elements of FIG. 3, the lock controller 344 may be controlled via interaction with particular controls as provided within or by an EPG or like interface, and information or data as acquired by the lock controller 344 may be manipulated, consolidated, etc., as desired, and also made accessible within or by an EPG or like interface in accordance with the principles of the present disclosure.

Further, a home security system, such as the home security system 306, may be integrated in to or as part of the home automation system 300. In general, the home security system 306 may detect motion, when a user has armed/disarmed the home security system 306, when windows/doors are opened or broken, etc. The PTR 110 may adjust settings of the home automation devices of FIG. 3 based on home security system 306 being armed or disarmed. For example, a virtual control and alarm panel may be presented to a user via the display device 330. The functions of a wall mounted panel alarm can be integrated in the graphical user interface of the TV viewing experience such as a menu system with an underlying tree hierarchical structure. It is contemplated that the virtual control and alarm panel can appear in a full screen or PiP (Picture-in-Picture) with TV content. Alarms and event notification can be in the form of scrolling text overlays, popups, flashing icons, etc.

Additionally, camera video and/or audio, such as from the security camera 308, can be integrated with DVR content provided by the PTR 110 with additional search, zoom, time-line capabilities. The camera's video stream can be displayed full screen, PiP with TV content, or as a tiled mosaic to display multiple camera's streams at a same time. In some examples, the display can switch between camera streams at fixed intervals. The PTR 110 may perform video scaling, adjust frame rate and transcoding on video received from the security camera 308. In addition, the PTR 110 may adaptively transcode the camera content to match an Internet connection. Here, as well as in all instances of home automation related data as acquired and served to the PTR 110 and/or overlay device 328 by particular elements of FIG. 3, the home security system 306 may be controlled via interaction with particular controls as provided within or by an EPG or like interface, and information or data as acquired by the home security system 306 may be manipulated, consolidated, etc., as desired, and also made accessible within or by an EPG or like interface in accordance with the principles of the present disclosure.

Further, an irrigation controller, such as the irrigation controller 346, may be integrated in to or as part of the home automation system 300, and may allow for a status and control of an irrigation system, such as a sprinkler system, to be controlled by a user via the PTR 110 and/or overlay device 328. The irrigation controller 346 may be used in conjunction with the weather sensor 314 to determine whether and/or for how long (duration) the irrigation controller 346 should be activated for watering. Further, a user, via the PTR 110 and/or overlay device 328, may turn on, turn off, or adjust settings of the irrigation controller 346. Here, as well as in all instances of home automation related data as acquired and served to the PTR 110 and/or overlay device 328 by particular elements of FIG. 3, the irrigation controller 346 may be controlled via interaction with particular controls as provided within or by an EPG or like interface, and information or data as acquired by the irrigation controller 346 may be manipulated, consolidated, etc., as desired, and also made accessible within or by an EPG or like interface in accordance with the principles of the present disclosure.

Further, a doorbell sensor, such as the doorbell sensor 348, may be integrated in to or as part of the home automation system 300, and may permit an indication of when a doorbell has been rung to be sent to multiple devices, such as the PTR 110 and/or the third party device 320. In some examples, the doorbell sensor 348 detecting a doorbell ring may trigger video to be recorded by the security camera 308 of the area near the doorbell and the video to be stored until deleted by a user, or stored for predefined period of time. Here, as well as in all instances of home automation related data as acquired and served to the PTR 110 and/or overlay device 328 by particular elements of FIG. 3, the doorbell sensor 348 may be controlled via interaction with particular controls as provided within or by an EPG or like interface, and information or data as acquired by the doorbell sensor 348 may be manipulated, consolidated, etc., as desired, and also made accessible within or by an EPG or like interface in accordance with the principles of the present disclosure.

For example, “selection” of a doorbell by an individual so as to “trigger” the doorbell sensor 348 may activate or engage the PTR 110 to generate and output for display by a presentation device, such as the television 114c, a user interface, display, pop-up, etc., that which may include particular information such as “There is someone at your front door ringing the doorbell” for example. Additional, or alternative, actions such as activating, by the PTR 110, a security camera to record video and/or audio of the individual at the front door are contemplated as well. Further, similar steps or actions may be taken or implemented by the PTR 110 for example in response to a signal generated in response to detection of an event, etc., received by the PTR 110 from any of the elements of FIG. 1.

Additional forms of sensors not illustrated in FIG. 1 may also be incorporated as part of the home automation system 300. For instance, a mailbox sensor may be attached to a mailbox to determine when mail is present and/or has been picked up. The ability to control one or more showers, baths, and/or faucets from the PTR 110 and/or the third party device 320 may also be possible. Pool and/or hot tub monitors may be incorporated into the home automation system 300. Such sensors may detect whether or not a pump is running, water temperature, pH level, a splash/whether something has fallen in, etc. Further, various characteristics of the pool and/or hot tub may be controlled via the home automation system. In some examples, a vehicle “dashcam” may upload or otherwise make video/audio available to the PTR 110 when within range of a particular residence. For instance, when a vehicle has been parked within range of a local wireless network with which the PTR 110 is connected, video and/or audio may be transmitted from the dashcam to the PTR 110 for storage and/or uploading to a remote server, such as the server 118 as shown in FIG. 1. Here, as well as in all instances of home automation related data as acquired and served to the PTR 110 and/or overlay device 328 by particular elements of FIG. 3, such systems or sensors or devices may be controlled via interaction with particular controls as provided within or by an EPG or like interface, and information or data as acquired by such systems or sensors or devices may be manipulated, consolidated, etc., as desired, and also made accessible within or by an EPG or like interface in accordance with the principles of the present disclosure.

In the example of FIG. 4, it is contemplated that the display device 330 may include or comprise multiple inputs and/or communication interfaces, such as three or four for example, to enable the establishment of a communication connection(s) between the display device 330 and the overlay device 328, DVR device, Roku® device, etc. Additionally, it is contemplated that “switching inputs” of the display device 330 may serve to enable the features or aspects of the present disclosure; however, it is contemplated that a device that was outputting a specific channel may switch inputs as well as channels to enable the features or aspects of the present disclosure. Still many other embodiments are possible as well. Further it is contemplated that the component 402 or the FSS module 120 may implement a set of rules whereby some may be set by the system or service provider 102 and/or some of which may be user-enabled. In this way, each user may determine what he/she wanted to be interrupted by. For instance, an individual could decide whether or not a backyard motion detection would interrupt his/her TV viewing experience. Additionally, it is contemplated that the end-user may disable the system for specific time periods to allow for suppressing an interrupt for a specific program that the end user would usually want to be high priority. Still many other features or aspects are contemplated, some of which may or may not be implementation-specific.

Referring now to FIG. 4, first aspects of the example home automation system 300 of FIG. 3 are shown in detail, including an example sequence for commanding a presentation device to switch between A/V inputs when it is determined that “higher” priority A/V signals are to be supplied to a presentation device for output thereby, in place of “lower” priority A/V signals currently or instantly output thereby, is shown in accordance with the present disclosure.

In particular, the PTR 110, the third party device 320, the overlay device 328, and the display device 330 of FIG. 3 are shown in FIG. 4. In this example, the PTR 110 and the overlay device 328 are logically grouped together as a component 402 (other embodiments are contemplated) that includes at least one communication interface 404, that which may be configured in a manner similar to the communication interface 228 discussed above on connection with FIG. 2 and so in general may take or exhibit any form as desired, and may be configured in a manner so as to be compatible with a like component or element incorporated within or to a particular one of the computing systems and devices as shown in at least FIG. 4, including at least one communication interface 406 of the display device 330 and possibly at least one communication interface 408 of the third party device 320. Accordingly, it is contemplated that the communication interface 406 of the display device 330 and the communication interface 408 of the third party device 320 may too be configured in a manner similar to the communication interface 228 discussed above in connection with FIG. 2.

In the present example, assume that a particular A/V input of the display device 330, “A/V input A” (or, alternatively, “Channel A”) for example, is selected so that media content 410 as supplied by the third party device 320 to the display device 330 is “currently,” or at a time t₁, being output by the display device 330 on a screen 412 of the display device 330. Next, assume that at a subsequent time t₂ the component 402, in response to receiving particular data or signals as initially acquired by the home security system 306 and/or security camera 308 of the home automation system 300 of FIG. 3 for example, instantiates a process to supply or provide a security camera feed 414 to the display device 330 for output thereby, on the screen 412.

In this example, the “A/V input A” of the display device 330 may not necessarily be an A/V input that would allow for someone watching the media content 410 on the screen 412 to watch or otherwise access the security camera feed 414. To address such an issue, it is contemplated that the FSS module 120 of the PTR 110 may instantiate a command 416 that is transferred from the communication interface 404 of the component 402 to the communication interface 406 of the display device 330, to forcibly command the display device 330 to switch from the “A/V input A” to an “A/V input B” (or, alternatively, “Channel B”), so that the security camera feed 414, which may in general be considered preferred or priority content, may be output for display on the screen 412 of the display device 330.

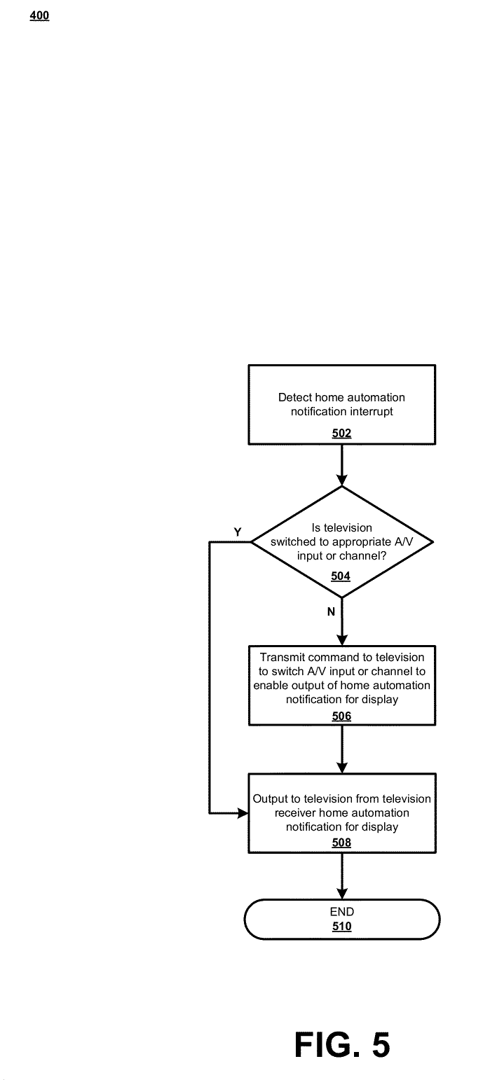

Advantageously, such an implementation as discussed in connection with FIG. 4 may ensure that the noted home automation-related information or notification, the security camera feed 414 in this example, is output for display by the display device 330 as may be considered to be intended in light of the context of the present disclosure. Specifically, the component 402 in general may be configured and/or arranged to receive data or signals, either directly or indirectly, from various home automation-related devices or components each positioned at a particular location within a residence, and may further be programmed to output for display certain home automation-related content when applicable or as desired. FIG. 5 illustrates an example method 500 consistent with the example implementation-specific scenario discussed in connection with FIG. 4.

Referring now to FIG. 5, an example method 500 is shown in accordance with the principles of the present disclosure. The method 500 is described as implemented by or on the component 402 of FIG. 4. Other embodiments are however possible. For example, one or more modules or steps of the example method 500 may be implemented by one or more of the other respective devices or components within the example system 100 of FIG. 1 and/or the example home automation system 300 of FIG. 3.

At step 502, the component 402 may detect receipt of an “interrupt” that which may function as a cue or command for the component 402 to instantiate a process to supply or provide particular home automation-related information or data to the display device 330 for output thereby. In general, the interrupt may be generated by one or more of the components or elements of the example home automation system 300 of FIG. 3 and then transferred to the component 402, or may be generated by the component 402 itself in response to a signal received by the component 402 from one or more of the components or elements of the home automation system 300 of FIG. 3. For example, the home security system 306 and/or security camera 308 of the home automation system 300 of FIG. 3 may send or transfer or transmit a signal to the component 402 to indicate that an individual approaching a front door has been detected, and that a security camera feed will be supplied to the display device 330 for display or output. This is just an example, other examples are possible.

Next, at step 504, the component 402 may determine whether or not the display device 330 is switched to an appropriate or proper A/V input or channel, so that the same may output the above-mentioned (step 502) particular home automation-related information or data. When the component 402 determines that the display device 330 is switched to an appropriate or proper A/V input or channel, process flow in the example method 500 may branch to step 508, discussed further below. When though the component 402 determines that the display device 330 is not switched to an appropriate or proper A/V input or channel, process flow in the example method 500 may branch to step 506.

At step 506, the component 402 may transmit a command to the display device 330 to a current or instant A/V input or channel to an appropriate or proper A/V input or channel, so that the same may output the above-mentioned (step 502) particular home automation-related information or data. For example, the command 416 (see FIG. 4) may be transferred from the communication interface 404 of the component 402 to the communication interface 406 of the display device 330, to forcibly command the display device 330 to switch from “A/V input A” to “A/V input B,” so that the security camera feed 414, which may in general be considered preferred or priority content, may be output for display on the screen 412 of the display device 330.

In this example, a type or form of the command 416 may be implementation-specific, and depend on type or form of the communication interface 404 and/or communication interface 406. For instance, a type or form of the command 416 may correspond to an IR (Infrared) “blast” that may be detected by the communication interface 406 of the display device 330 to enable or command the display device 330 to switch from “A/V input A” to “A/V input B,” or from a “Channel A” to a “Channel B,” and etc. Many other examples are possible as well. For instance, in a hard-wired implementation a CEC-type command be transmitted “over-wire” to enable or command the display device 330 to switch from “A/V input A” to “A/V input B,” or from a “Channel A” to a “Channel B,” and etc. Still many other examples are possible.

Next, at step 508, the component 402 may output the above-mentioned (step 502) particular home automation-related information or data to the display device 330 for output thereby. For instance, the component 402 may output the security camera feed 414 for display on the screen 412 of the display device 330. This is just an example, other examples are possible. Process flow within the example method may then terminate at step 510.

Consistent with the examples discussed throughout, including that presented in connection with FIG. 5, it is contemplated that there may be any combination of system, service provider items, and user selected items that may cause output of a video notification(s) by or on the overlay device 330 and the screen 412. Some examples include, but are not limited to, someone at from door as determined by camera, motion detector, audio detector, doorbell, etc., basement leak detector; CO alarm; glass break or window/door sensor trip. Additionally, in many instances, any particular TV may not be able to determine by itself what channel/input the TV is on. In this example, when the home automation device or system of the present disclosure determines it needs to tell the user something, it may command the TV to the appropriate mode. Additionally, it is contemplated that some or certain alarms may trigger the overlay device 328, for example, to turn the display device 330 “on,” that which itself may serve as an alarm, deterrent, notification, etc., such as if a burglar alarm is tripped or example, and the same may be user-defined and/or user-configurable. Other examples are possible, some of which may or may not be implementation-specific.

Referring now to FIG. 6, second aspects of the example home automation system 300 of FIG. 3 are shown in detail, In particular, the PTR 110 may be configured to output an EPG (Electronic Programming Guide) 602 to and for presentation the television 114c, for example. The EPG 602 may at least present various information related to television channels and the timing of programs or programming appearing on such television channels. For example, as shown in FIG. 6, the EPG 602 may display information associated with a channel 2014, where the “World Series” is listed as scheduled to appear on that channel starting at a particular time on a particular day, and etc. In this example, and assuming that a current time is sometime during the time period 8-10 PM, a viewer may manipulate a cursor 604 using a pointing device (not shown) to select, as shown by stipple shading in FIG. 6, the World Series for immediate viewing within a window 606. Other examples are possible. For example, it is contemplated that any menu-driven navigation technique or implementation may be used to enable user-interaction with the EPG 602, along with other elements or interfaces output by the PTR 110 to the television 114c.

In addition to the EPG 602, the PTR 110 may be configured to output various other interactive elements or interfaces. For example, the FSS module 120 may be configured to output a feed selection configuration button 608. In general, the feed selection configuration button 608 may be selected so that the FSS module 120 is configured to implement the various features or aspects of the present disclosure according to end-user preferences. For example, an end-user may manipulate the cursor 604 to select the feed selection configuration button 608, via a “point and double-click” action or “point and click” action or a “highlight and select” action using a remote control for example and, in response, the FSS module 120 may be configured to output a configuration interface 610 to enable the end-user to configure the FSS module 120 to command the television 114c, for example, to switch between A/V inputs or channels when it is determined that “higher” priority A/V signals are to be supplied to the presentation device for output thereby, in place of “lower” priority A/V signals currently or instantly output thereby, according to their preferences.

For example, the configuration interface 610 may at least include an interrupt permission section 612 that includes or identifies a particular status or condition associated with ones of the components or elements of the example home automation system 300 of FIG. 3. It is contemplated that such items when “selected” via “double-click” for example, indicated by intermittent line in FIG. 6, may enable or program the FSS module 120 to generate an interrupt when a particular status or condition is positively detected. For example, when status or condition “Security Camera; Motion Detected” is fulfilled, the FSS module 120 may generate an interrupt to instantiate the example method 500 as shown and described above in connection with FIG. 5. Many other example are possible as well, the same of which may only be limited by the arrangement and/or configuration of the example home automation system 300 of FIG. 3.

The example configuration interface 610 may additionally include a definitions button 614 and an enable button 616. In general, it is contemplated that an end-user may manipulate the cursor 604 to select the definitions button 614 to define, via QWERTY keypad for example, a particular status or condition associated with ones of the components or elements of the example home automation system 300 of FIG. 3. For example, an end-user may enter the phrase “Clothes Washer; Spin Cycle Complete” or “Garage Door Ajar” as shown in FIG. 6 for example. These are just examples, other examples are possible. Further, it is contemplated that an that an end-user may manipulate the cursor 604 to select the enable button 616 to enable or disable the FSS module 120 to implement the features or aspects of the present disclosure.

FIG. 7 shows an example computer system or device 700 in accordance with the disclosure. An example of a computer system or device includes an enterprise server, blade server, desktop computer, laptop computer, tablet computer, personal data assistant, smartphone, gaming console, STB, television receiver, and/or any other type of machine configured for performing calculations. Any particular one of the previously-described computing devices may be wholly or at least partially configured to exhibit features similar to the computer system 700, such as any of the respective elements of at least FIGS. 1-4. In this manner, any of one or more of the respective elements of at least those figures may be configured to perform and/or include instructions that, when executed, perform the method of FIG. 5. Still further, any of one or more of the respective elements of at least FIG. 1 may be configured to perform and/or include instructions that, when executed, instantiate and implement functionality of the PTR 110 and/or the server(s) 118. It is contemplated that the instance of the FSS module 120 on the server 118 may be a “back-up” to the instance of the FSS module 120 on the PTR 110, and in some instances “updates” to the instance of the FSS module 120 on the PTR 110 may be pushed to the same from the instance of the FSS module 120 on the server 118. Other benefits and/or advantages of having an instance(s), possible customer-specific, of the FSS module 120 stored to the server 118 are possible as well.

The computer device 700 is shown comprising hardware elements that may be electrically coupled via a bus 702 (or may otherwise be in communication, as appropriate). The hardware elements may include a processing unit with one or more processors 704, including without limitation one or more general-purpose processors and/or one or more special-purpose processors (such as digital signal processing chips, graphics acceleration processors, and/or the like); one or more input devices 706, which may include without limitation a remote control, a mouse, a keyboard, and/or the like; and one or more output devices 708, which may include without limitation a presentation device (e.g., television), a printer, and/or the like.

The computer system 700 may further include (and/or be in communication with) one or more non-transitory storage devices 710, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 700 might also include a communications subsystem 712, which may include without limitation a modem, a network card (wireless and/or wired), an infrared communication device, a wireless communication device and/or a chipset such as a Bluetooth™ device, 702.11 device, WiFi device, WiMax device, cellular communication facilities such as GSM (Global System for Mobile Communications), W-CDMA (Wideband Code Division Multiple Access), LTE (Long Term Evolution), etc., and/or the like. The communications subsystem 712 may permit data to be exchanged with a network (such as the network described below, to name one example), other computer systems, and/or any other devices described herein. In many embodiments, the computer system 700 will further comprise a working memory 714, which may include a random access memory and/or a read-only memory device, as described above.

The computer device 700 also may comprise software elements, shown as being currently located within the working memory 714, including an operating system 716, device drivers, executable libraries, and/or other code, such as one or more application programs 718, which may comprise computer programs provided by various embodiments, and/or may be designed to implement methods, and/or configure systems, provided by other embodiments, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 710 described above. In some cases, the storage medium might be incorporated within a computer system, such as computer system 700. In other embodiments, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer device 700) to perform methods in accordance with various embodiments of the disclosure. According to a set of embodiments, some or all of the procedures of such methods are performed by the computer system 700 in response to processor 704 executing one or more sequences of one or more instructions (which might be incorporated into the operating system 716 and/or other code, such as an application program 718) contained in the working memory 714. Such instructions may be read into the working memory 714 from another computer-readable medium, such as one or more of the storage device(s) 710. Merely by way of example, execution of the sequences of instructions contained in the working memory 714 may cause the processor(s) 704 to perform one or more procedures of the methods described herein.

The terms “machine-readable medium” and “computer-readable medium,” as used herein, may refer to any non-transitory medium that participates in providing data that causes a machine to operate in a specific fashion. In an embodiment implemented using the computer device 700, various computer-readable media might be involved in providing instructions/code to processor(s) 704 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 710. Volatile media may include, without limitation, dynamic memory, such as the working memory 714.

Example forms of physical and/or tangible computer-readable media may include a floppy disk, a flexible disk, hard disk, magnetic tape, or any other magnetic medium, a compact disc, any other optical medium, ROM (Read Only Memory), RAM (Random Access Memory), and etc., any other memory chip or cartridge, or any other medium from which a computer may read instructions and/or code. Various forms of computer-readable media may be involved in carrying one or more sequences of one or more instructions to the processor(s) 704 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 712 (and/or components thereof) generally will receive signals, and the bus 702 then might carry the signals (and/or the data, instructions, etc. carried by the signals) to the working memory 714, from which the processor(s) 704 retrieves and executes the instructions. The instructions received by the working memory 714 may optionally be stored on a non-transitory storage device 710 either before or after execution by the processor(s) 704.

It should further be understood that the components of computer device 700 can be distributed across a network. For example, some processing may be performed in one location using a first processor while other processing may be performed by another processor remote from the first processor. Other components of computer system 700 may be similarly distributed. As such, computer device 700 may be interpreted as a distributed computing system that performs processing in multiple locations. In some instances, computer system 700 may be interpreted as a single computing device, such as a distinct laptop, desktop computer, or the like, depending on the context.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
detecting, by a home automation system, a first command to establish a communication link between the home automation system and a particular presentation device;
generating, by the home automation system in response to detecting the first command, a second command to enforce the particular presentation device to exhibit a particular output display mode or status; and
transmitting, by the home automation system via the communication link, the second command to enforce the particular presentation device to exhibit the particular output display mode or status.

2. The method of claim 1, further comprising:
receiving the first command from a particular home automation component that is installed at a residence together with the home automation system and that is communicatively coupled to the home automation system.

3. The method of claim 1, further comprising:
generating, by the home automation system, the first command in response to a particular signal received from a particular home automation component that is installed at a residence together with the home automation system and that is communicatively coupled to the home automation system.

4. The method of claim 1, further comprising:
generating, by the home automation system in response to detecting the first command, the second command to enforce the particular presentation device to switch from a first audio/visual input to a second audio/visual input.

5. The method of claim 1, further comprising:
generating, by the home automation gateway in response to the first command, the second command to enforce the particular presentation device to switch from a first broadcast television channel to a second broadcast television channel.

6. The method of claim 1, further comprising:
transmitting the second command to enforce the particular presentation device to exhibit the particular output display mode or status via a hard-wired communication link.

7. The method of claim 1, further comprising:
transmitting the second command to enforce the particular presentation device to exhibit the particular output display mode or status via a wireless communication link.

8. The method of claim 1, further comprising:
transmitting the second command to enforce the particular presentation device to exhibit the particular output display mode or status via an infrared communication link.

9. The method of claim 1, further comprising:
outputting a particular audio stream for output by the presentation device.

10. The method of claim 1, further comprising:
outputting a particular video stream for output by the presentation device.

11. The method of claim 1, further comprising:
outputting at least one of a particular audio stream and a particular audio stream for output by the presentation device, that which is indicative of status or includes data as acquired by at least one home automation component that is installed at a residence together with the home automation system and that is communicatively coupled to the home automation system.

12. A home automation system, comprising:
at least one processor; and
at least one memory element communicatively coupled with and readable by at least one processor and having stored therein processor-readable instructions that, when executed by the at least one processor, cause the at least one processor to:
detect a first command to establish a communication link between the home automation system and a particular presentation device;
generate a second command to enforce the particular presentation device to exhibit a particular output display mode or status; and
transmit via the communication link the second command to enforce the particular presentation device to exhibit the particular output display mode or status.

13. The home automation system of claim 12, wherein the processor-readable instructions when executed by the at least one processor cause the at least one processor to:
generate the first command in response to a particular signal received from a particular home automation component that is installed at a residence together with the home automation system and that is communicatively coupled to the home automation system.

14. The home automation system of claim 12, wherein the processor-readable instructions when executed by the at least one processor cause the at least one processor to:
generate the second command to enforce the particular presentation device to switch from a first audio/visual input to a second audio/visual input.

15. The home automation system of claim 12, wherein the processor-readable instructions when executed by the at least one processor cause the at least one processor to:
generate the second command to enforce the particular presentation device to switch from a first broadcast television channel to a second broadcast television channel.

16. The home automation system of claim 12, wherein the processor-readable instructions when executed by the at least one processor cause the at least one processor to:
transmit the second command to enforce the particular presentation device to exhibit the particular output display mode or status via a hard-wired communication link.

17. The home automation system of claim 12, wherein the processor-readable instructions when executed by the at least one processor cause the at least one processor to:
transmit the second command to enforce the particular presentation device to exhibit the particular output display mode or status via a wireless communication link.

18. The home automation system of claim 12, wherein the processor-readable instructions when executed by the at least one processor cause the at least one processor to:
transmit a particular audio stream for output by the presentation device, that which is indicative of status or includes data as acquired by at least one home automation component that is installed at a residence together with the home automation system and that is communicatively coupled to the home automation system.

19. The home automation system of claim 12, wherein the processor-readable instructions when executed by the at least one processor cause the at least one processor to:
transmit a particular video stream for output by the presentation device, that which is indicative of status or includes data as acquired by at least one home automation component that is installed at a residence together with the home automation system and that is communicatively coupled to the home automation system.

20. A computer-implemented method, comprising:
detecting, by a television receiver, a first command to establish a communication link between the television receiver and a particular presentation device;
generating, by the television receiver in response to detecting the first command, a second command to enforce the particular presentation device to exhibit a particular output display mode or status; and
transmitting, by the television receiver via the communication link, the second command to enforce the particular presentation device to exhibit the particular output display mode or status.
